(19) United States
(12) Patent Application Publication
(10) Pub. No.: US 2011/0011540 A1
(43) Pub. Date: Jan. 20, 2011

(54) TAPE DISPENSER AND TAPE HOLDER

(75) Inventor: Toshihiro Kaneko, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/834,179

(22) Filed: Jul. 12, 2010

(30) Foreign Application Priority Data
Jul. 16, 2009 (JP) 2009-168014

(51) Int. Cl. B29C 65/50

(52) U.S. Cl. 156/538

(57) ABSTRACT

A tape dispenser includes: an attachment member for fixing on an apparatus; a tape holder; and an engaging member. The tape holder holds an adhesive tape in a manner that allows the adhesive tape to be reeled out. The engaging member is provided on the attachment member and the tape holder and removably engages the tape holder with the attachment member.

### CROSS-REFERENCE TO RELATED APPLICATION

This application is based upon and claims the benefit of priority from Japanese Patent Application No.2009-168014 filed on Jul. 16, 2009, the entire contents of which are incorporated herein by reference.

### FIELD

The present invention relates to a tape dispenser and a tape holder for an adhesive tape.

### BACKGROUND

Conventionally, it is a general practice to install, at a POS terminal, a tape dispenser which rotatably holds an adhesive tape such as an ordinary cellophane adhesive tape or a dedicated tape with a store name logo or the like printed thereon. The cashier uses the dedicated tape with the store name logo or the like printed thereon in order to prove the purchase of large-sized articles and the like, in addition to using the ordinary cellophane adhesive tape for packaging and to paste sales slips. JP-A-2001-310861 discloses a configuration having a tape holder which rotatably holds two adhesive tapes separately.

Among the adhesive tapes held on the tape dispenser, as for the dedicated tape used to prove the purchase, the cashier, when leaving a POS terminal, may store this dedicated tape in a drawer or the like of a table on which the POS terminal is installed, in order to prevent unauthorized use of the dedicated tape by customers.

### DESCRIPTION OF THE DRAWINGS

FIG. 1 is a schematic view of a POS terminal having a tape dispenser according to a first embodiment.

FIG. 2 is an exploded perspective view of the tape dispenser according to the first embodiment.

FIG. 3 is a perspective view of a tape holder.

FIG. 4 is a sectional view of the tape holder.

FIG. 5 is a schematic view of a POS terminal having a tape dispenser according to another embodiment.

FIG. 6 is an exploded perspective view of the tape dispenser according to another embodiment.

FIG. 7 is a front view of the POS terminal having the tape dispenser according to another embodiment.

FIG. 8 is an overhead view of the POS terminal having the tape dispenser according to another embodiment.

FIG. 9 is a sectional view of a tape holder according to still another embodiment.

FIG. 10 is a perspective view of a base metal plate according to still another embodiment.

### DETAILED DESCRIPTION

According to a embodiment of the invention, a tape dispenser includes: an attachment member for fixing on an apparatus; a tape holder; and an engaging member. The tape holder holds an adhesive tape in a manner that allows the adhesive tape to be reeled out. The engaging member is provided on the attachment member and the tape holder and removably engages the tape holder with the attachment member.

According to the embodiment of the invention, a tape holder includes an engaging member which removably engages with an attachment member for fixing on an apparatus, and holds an adhesive tape in a manner that allows the adhesive tape to be reeled out.

Hereinafter, the embodiment of a tape dispenser and a tape holder will be described in detail with reference to the attached drawings.

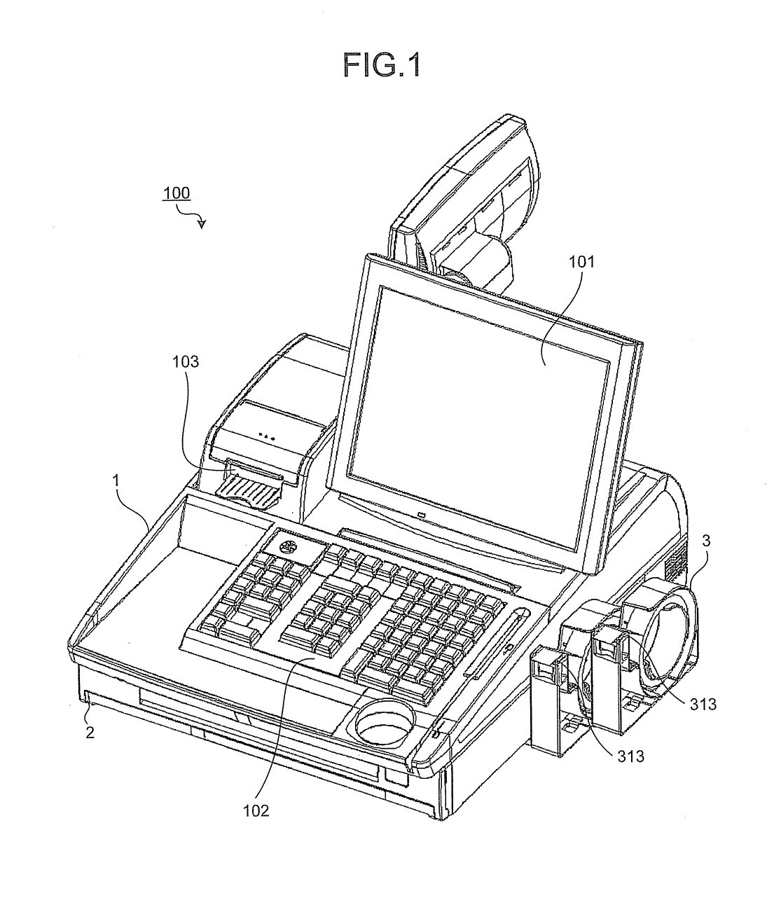

First, a first embodiment will be described. FIG. 1 is a schematic view of a POS terminal 100 having a tape dispenser 3 according to the first embodiment. As illustrated in FIG. 1, the POS terminal 100 has, at an upper part of a casing, a POS body 1 including an LCD 101 (liquid crystal display) provided with an operation screen, an operation unit 102 provided with operation keys and the like for a cashier to carry out accounting, and a receipt issue port 103 through which a printed receipt is discharged. A cash drawer 2 is provided in a lower part of the casing.

The tape dispenser 3 is installed on a lateral side of the casing of the POS terminal 100 as an apparatus. The tape dispenser 3 is also fixed to the POS terminal 100. Specifically, the tape dispenser 3 is fixed to the POS terminal 100 as a metal plate (which will be described in detail later) of the tape dispenser 3 is screwed to a bottom surface of the cash drawer 2 at a position that is on the right and close to the rear side of the cash drawer 2 and that contacts the right lateral side of the casing on the bottom right side of the POS body 1. In the state where the tape dispenser 3 is fixed to the POS terminal 100, a tape cutter 313 to cut an adhesive tape on the tape dispenser 3 is situated at a position that is closer to the rear side than the position of the vicinity of the operation unit 102 and the position of the vicinity of the receipt issue port 103 are. Therefore, the tape cutter 313 does not disturb the cashier's operation. In this embodiment, the POS terminal 100 is described as an exemplary apparatus. However, the apparatus is not particularly limited to the POS terminal 100 and may be a worktable on which the POS terminal 100 is installed.

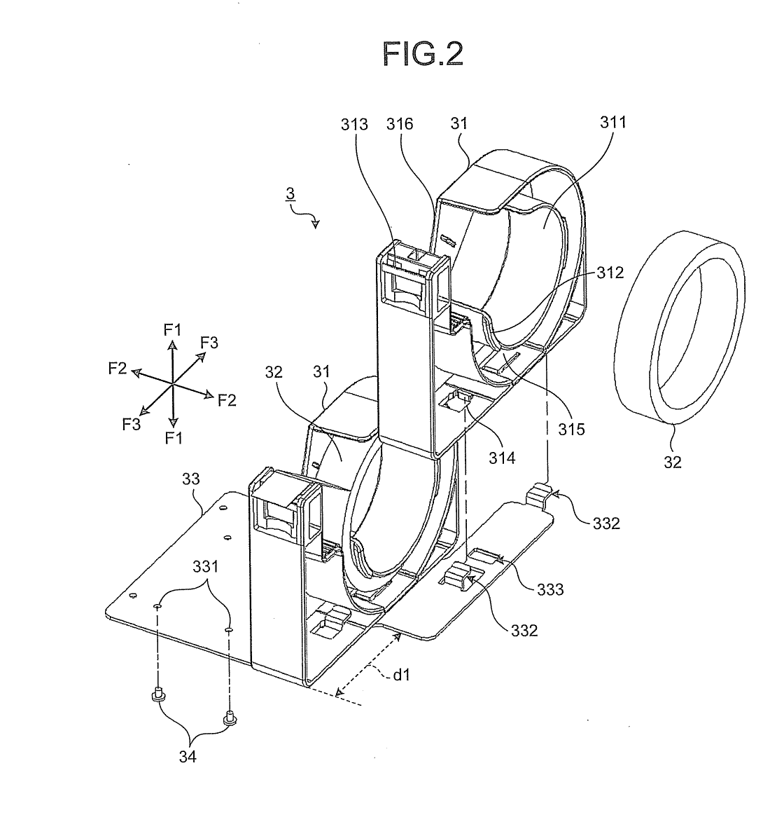

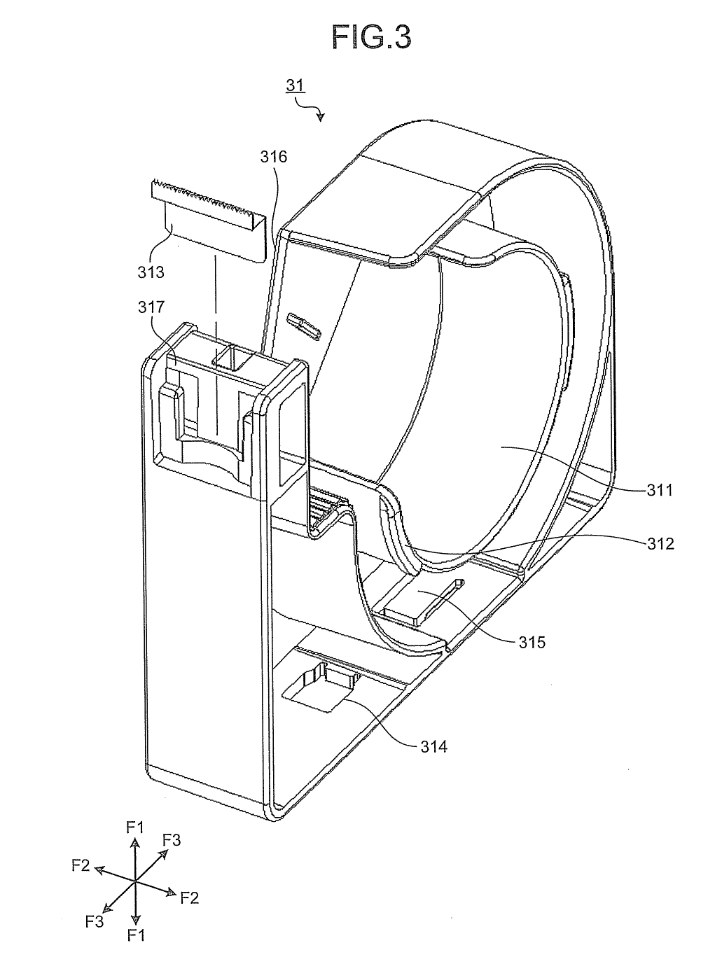

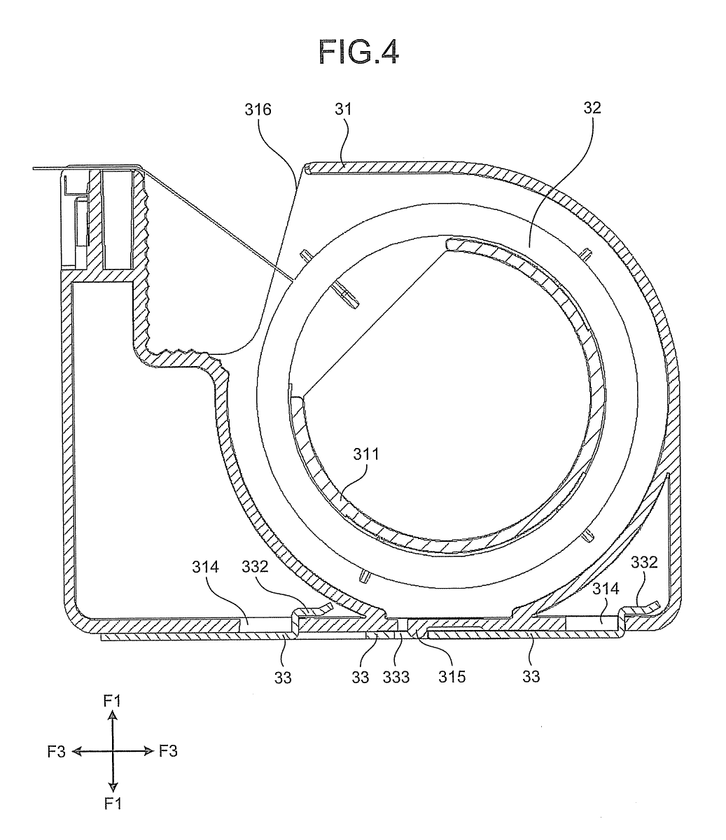

FIG. 2 is an exploded perspective view of the tape dispenser 3 according to the first embodiment. FIG. 3 is a perspective view of a tape holder 31. FIG. 4 is a sectional view of the tape holder 31. In FIG. 2 to FIG. 4, the F1-F1 direction is the vertical direction in FIG. 1. The F2-F2 direction is the direction of the width of the POS terminal 100 in FIG. 1. The F3-F3 direction corresponds to the direction of the depth of the POS terminal 100 in FIG. 1. As illustrated in FIG. 2, the tape dispenser 3 has a configuration in which the two tape holders 31 are installed on a base metal plate 33 as an attachment member for attaching and detaching the individual tape holder separately. In the embodiment, the base metal plate 33 is machined to have a screw hole and the like in a flat metal sheet. Each of the two tape holders 31 rotatably holds an adhesive tape 32 that is reeled in the shape of a ring. Therefore, in the tape dispenser 3, the tape holder 31 holding the adhesive tapes 32 can easily be detached according to the use of the POS terminal 100.

As shown in FIG. 3 and FIG. 4, a tape holding part 311 for loading the ring-like adhesive tape 32 is formed on the tape holder 31. Specifically, the tape holding part 311 is a member shaped in the form of an approximately three-quarter arc-like protrusion. The diameter of the arc is slightly smaller than the inner diameter of the ring-like adhesive tape 32. The height of the member is greater than the width of the adhesive tape 32. At a part on the outer circumference of the tape holding part 311, a stopper 312 to prevent lateral shift of the loaded adhesive tape 32 is provided in a protruding manner. Since the stopper 312 is thus provided, it is difficult in this state to load the adhesive tape 32 on the tape holding part 311, which is formed with the slightly smaller diameter than the inner diameter of the ring-like adhesive tape 32. However, since the tape holding part 311 is formed in the approximately three-quarter arc shape so that the tape holding part 311 can be elastically deformed at the time of loading the adhesive tape 32, the adhesive tape 32 can easily be loaded. Thus, in the tape holder 31, the tape holding part 311 rotatably holds the adhesive tape 32.

The tape holder 31 also has a tape discharge part 316 to reel out and discharge the adhesive tape 32 loaded on the tape holding part 311, and the tape cutter 313 to cut the adhesive tape 32 that is reeled out. Specifically, the tape discharge part 316 is an aperture that is formed on a lateral side and the top part of the tape holder 31 so that the adhesive tape 32 loaded on the tape holding part 311 can easily be held by fingers. Therefore, as the adhesive tape 32 loaded on the tape holding part 311 is held, for example, by fingers inserted from the lateral side of the tape holder 31 and reeled out upward, the adhesive tape 32 is discharged outward. The tape cutter 313 cuts the adhesive tape 32 where the adhesive tape 32 is reeled out upward and pulled forward. Therefore, the tape cutter 313 is held on the tape holder 31 by a tape cutter holding part 317 with the cutting edge of the tape cutter 313 facing upward. On a bottom side of the tape holder 31 that contacts the base metal plate 33 when the tape holder 31 is attached thereto, a bottom hole 314 and a snap-fit pawl 315 are provided.

As illustrated in FIG. 2, a screw hole 331 for fixing the base metal plate 33 to the bottom surface of the cash drawer 2 with a screw 34 is formed in the base metal plate 33. The base metal plate 33 is partially fixed to the cash drawer 2 at the bottom with the screw 34. The base metal plate 33 has a protrusion 332 and a base hole 333 for removably attaching (or engaging) the tape holder 31 in the state where the base metal plate 33 is fixed to the cash drawer 2 with the screw 34. The protrusion 332 as regulating members is formed into an L-shape bent from the halfway part toward the depth in the F3-F3 direction. As illustrated in FIG. 2 and FIG. 4, in the case of attaching the tape holder 31 to the base metal plate 33, the protrusion 332 is inserted in the bottom hole 314 of the tape holder 31 and the tape holder 31 is pulled forward in the F3-F3 direction. Thus, the bottom wall of the tape holder 31 is caught by the L-shaped protrusion 332 and the tape holder 31 is attached to the base metal plate 33. At this time, as illustrated in FIG. 4, the snap-fit pawl 315, which is pressed down by an elastic force, enters and fits with the base hole 333 as a lock mechanism. As the snap-fit pawl 315 fits the base hole 333, the tape holder 31 is locked (or fixed) on the base metal plate 33. That is, as the tape holder 31 is pulled forward in the F3-F3 direction, that is, the same as the direction of reeling out the adhesive tape 32, the bottom wall of the tape holder 31 is caught by the L-shaped protrusion 332 and the movement of the tape holder 31 is regulated. Thus, the tape holder 31 does not shift when the cashier reels out the adhesive tape 32.

The above state where the tape holder 31 is locked on the base metal plate 33 is canceled if a predetermined force is applied to the tape holder 31 toward the depth in the F3-F3 direction so that the snap-fit pawl 315, pressed down by an elastic force, is pushed back. Therefore, if a predetermined force is applied to the tape holder 31 to slide toward the depth in the F3-F3 direction and then the protrusion 332 is pulled out of the bottom hole 314, the tape holder 31 locked on the base metal plate 33 is released from the base metal plate 33. The direction in which an applied force to release the tape holder 31 from the base metal plate 33 is toward the depth in the F3-F3 direction and is opposite to the direction of reeling out the adhesive tape 32. Therefore, unexpected detachment of the tape holder 31 does not occur when the cashier reels out the adhesive tape 32.

The base metal plate 33 attachably and detachably retains the two tape holders 31. Specifically, the base metal plate 33 retains, among the two tape holders 31 retained on the right side of the POS body 1, the tape holder 31 on the far side from the POS body 1, which is shifted toward the depth by a distance d1 only in the F3-F3 direction with respect to the tape holder 31 on the near side from the POS body 1. The d1 enables the cashier to insert fingers from the right side of the tape discharge part 316 and reel out the adhesive tape 32 for both of these tape holders 31 even if the two tape holders 31 are attached to the base metal plate 33.

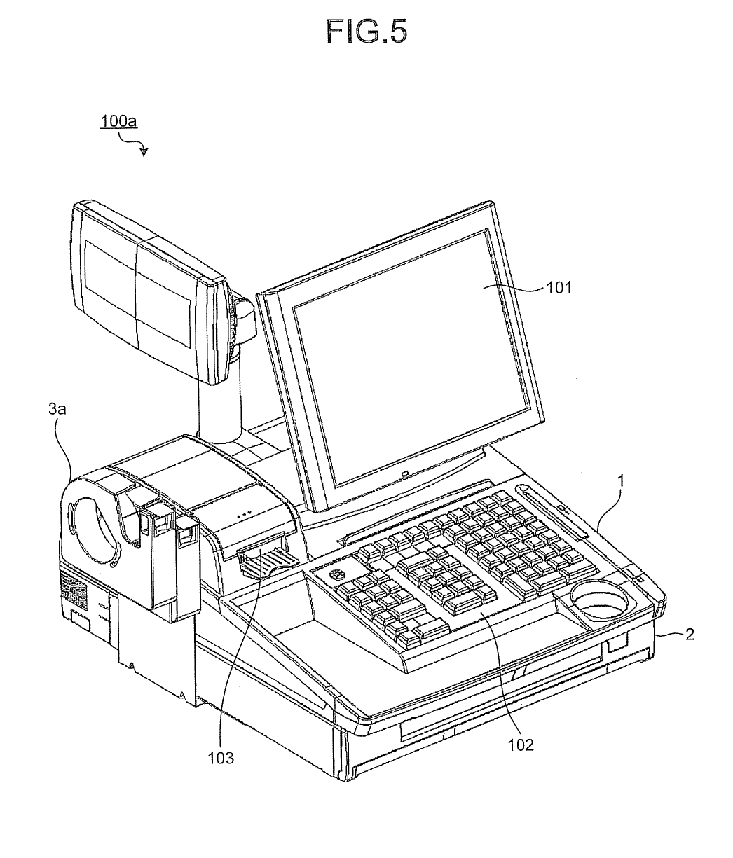

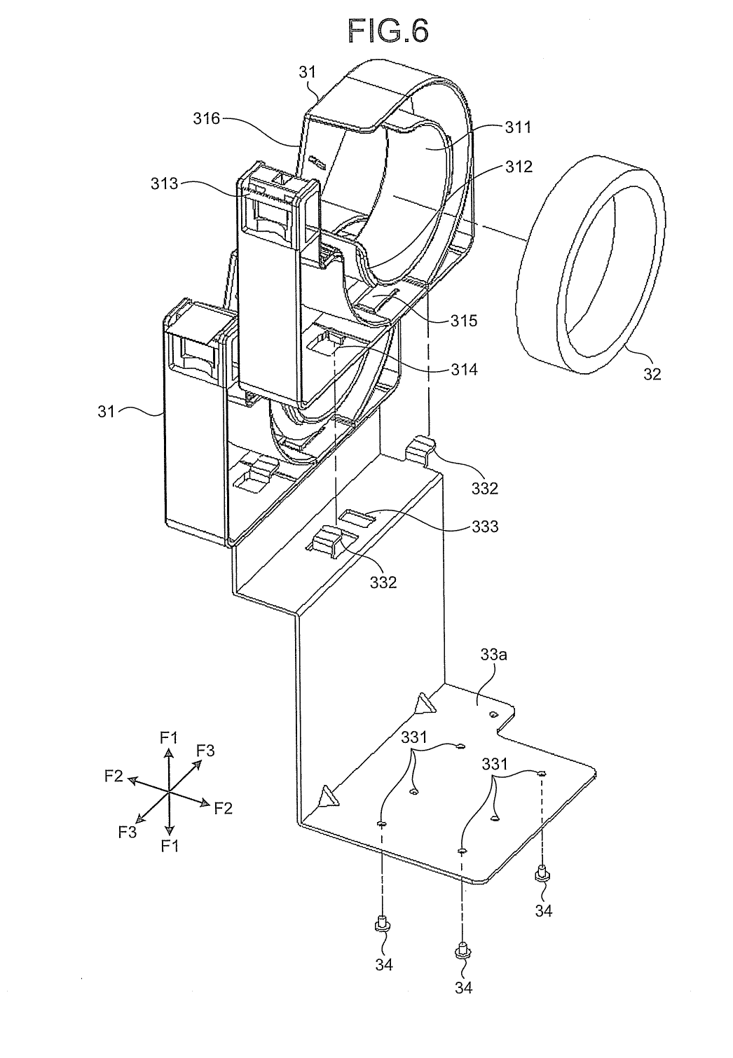

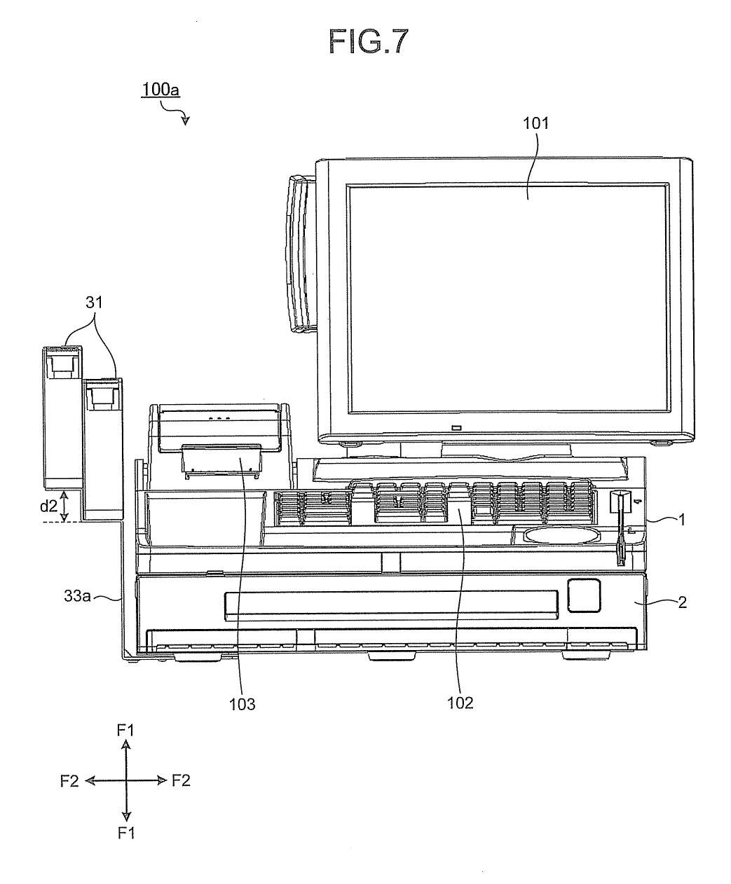

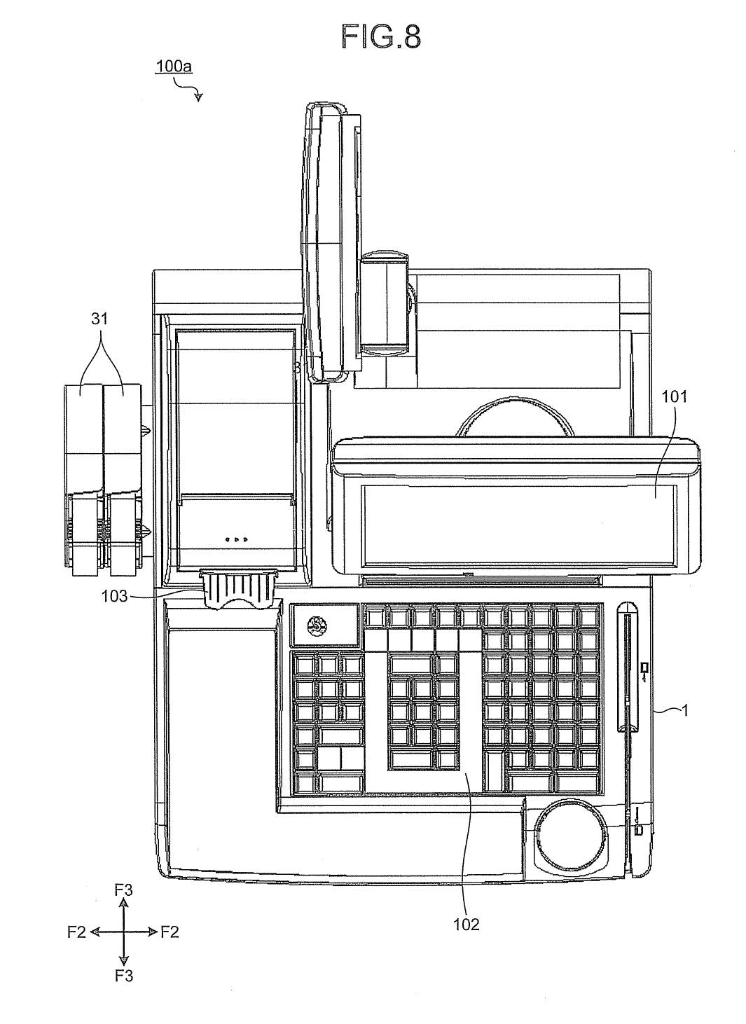

Next, another embodiment will be described with reference to FIG. 5 to FIG. 8. FIG. 5 is a schematic view of a POS terminal 100a having a tape dispenser 3a according to another embodiment. FIG. 7 is a front view of the POS terminal 100a. FIG. 8 is an overhead view of the POS terminal 100a. FIG. 6 is an exploded perspective view of the tape dispenser 3a according to another embodiment. The same elements as in the first embodiment are denoted by the same reference numerals and will not be described further in detail.

As illustrated in FIG. 5, FIG. 7 and FIG. 8, the POS terminal 100a equips the tape dispenser 3a on the left lateral side of its casing. As illustrated in FIG. 6 and FIG. 7, for the tape dispenser 3a, the two tape holders 31 are attachably and detachably retained using a base metal plate 33a with a step d2. Specifically, the base metal plate 33a retains, among the two tape holders 31 attached to and detached from the left side of the POS body 1, the tape holder 31 on the far side from the POS body 1, which is shifted upward with respect to the tape holder 31 on the near side from the POS body 1. This step d2 enables the cashier to insert fingers from the right side of the tape discharge part 316 and reel out the adhesive tape 32 with respect to both of the tape holders 31 even in the case that the two tape holders 31 are mounted on the base metal plate 33a.

The position where the tape holder 31 is attached and detached and the number of the tape holder 31 are not limited to those in the layouts described in the first and another embodiment. For example, the number of the tape holders 31 attached to and detached from the tape dispensers 3 and 3a may be one, or two or more. If more than the one tape holder 31 is attached and detached, the layout in which the difference d1 in the back and forth direction or the step d2 is provided between the positions of installation of the tape holder 31 is not limited to the layout that enables the cashier to insert fingers from the right side of the tape discharge part 316 and reel out the adhesive tape 32. For example, a layout may be employed that enables the cashier to insert fingers from the left side of the tape discharge part 316 and reel out the adhesive tape 32. If the difference d1 in the back and forth direction is provided between the positions of installation, the tape holder 31 on the left may be shifted toward the depth from the tape holder 31 on the right at the time of attachment and detachment. If the step d2 is provided between the positions of installation, the tape holder 31 on the right may be shifted upward from the tape holder 31 on the left at the time of attachment and detachment.

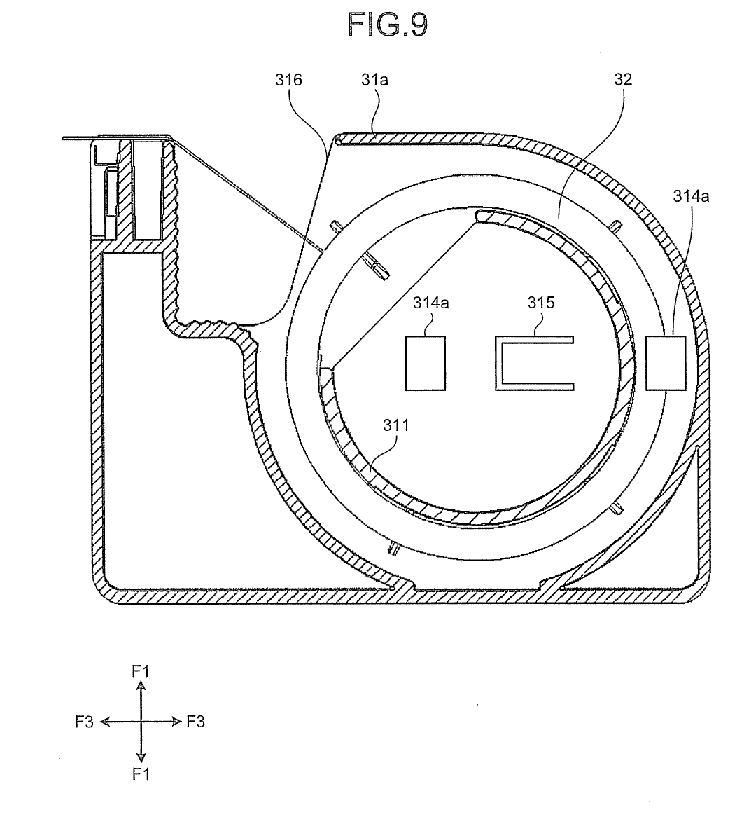

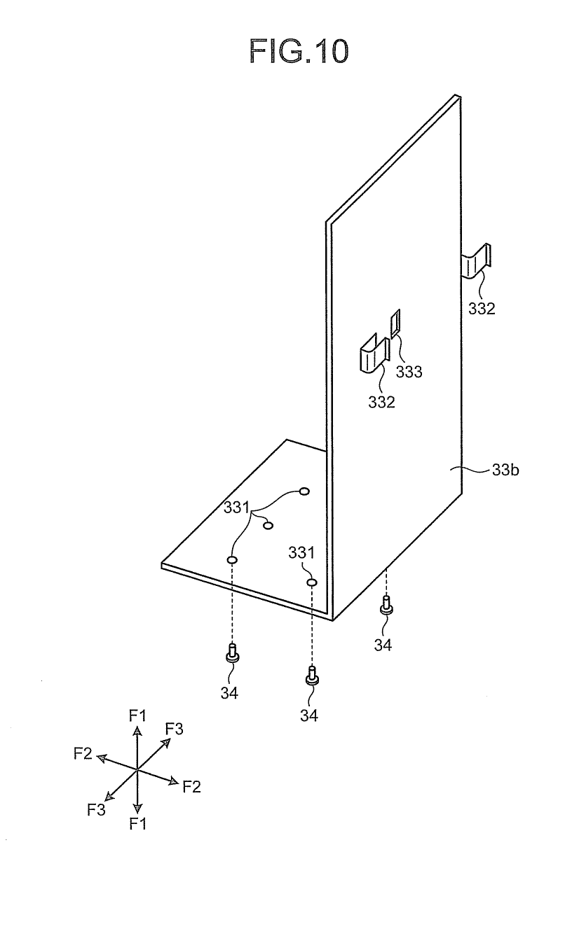

Next, a still another embodiment will be described with reference to FIG. 9 and FIG. 10. In the first and another embodiment, the configuration in which the tape holders are installed on the base metal plate from above (in the F1-F1 direction) is described. However, in still another embodiment, a configuration in which the tape holder is installed on abase metal plate from a lateral side (in the F2-F2 direction) is described. FIG. 9 is a sectional view of a tape holder 31a according to still another embodiment. FIG. 10 is a perspective view of a base metal plate 33b according to still another embodiment.

As illustrated in FIG. 9, the tape holder 31a has a lateral hole 314a and the snap-fit pawl 315 on a lateral side. As illustrated in FIG. 10, the base metal plate 33b has the protrusion 332 to attach and detach the tape holder 31a in the F2-F2 direction, and the base hole 333.

The embodiments are not limited to the above-described forms. In the implementation stage, components can be modified and thus embodied without departing from the scope of the invention. Suitable combinations of plural components disclosed in the embodiments enable various other forms of the invention. For example, some of the components described in the embodiments may be deleted. Moreover, components from different embodiments may be suitably combined.

Further advantages and modifications can easily occur to those skilled in the art. Thus, broader forms of the invention are not limited to the specific details and representative embodiments described and illustrated above. Therefore, various changes and alterations can be made without departing from the scope and spirit of the general concept of the invention defined by the attached claims and their equivalents.

While certain embodiments have been described, these embodiments have been presented by way of example only, and are not intended to limit the scope of the inventions. Indeed, the novel tape dispensers and holders described herein may be embodied in a variety of other forms; furthermore, various omissions, substitutions and changes in the form of the tape dispensers and holders described herein may be made without departing from the spirit of the inventions. The accompanying claims and their equivalents are intended to cover such forms or modifications as would fall within the scope and spirit of the inventions.

What is claimed is:

1. A tape dispenser comprising:
an attachment member for fixing on an apparatus;
a tape holder which holds an adhesive tape in a manner that allows the adhesive tape to be reeled out; and
an engaging member provided on the attachment member and the tape holder and removably engaging the tape holder with the attachment member.

2. The tape dispenser of claim 1, wherein the engaging member has a regulating member which regulates movement of the tape holder in the same direction as a direction of reeling out the adhesive tape held by the tape holder attached to the attachment member.

3. The tape dispenser of claim 1, wherein the engaging member has a lock mechanism which locks the tape holder until a predetermined force is applied, in a direction opposite to the direction of reeling out.

4. The tape dispenser of claim 3, wherein the lock mechanism locks the tape holder as a pawl that is pressed by an elastic force enters a hole.

5. The tape dispenser of claim 1, comprising more than the one engaging member,
wherein more than the one tape holder is attached to the attachment member alternately in a back and forth direction by more than the one engaging member.

6. The tape dispenser of claim 1, comprising more than the one engaging member,
wherein more than the one tape holder is attached to the attachment member alternately stepwise in a vertical direction by more than the one engaging member.

7. The tape dispenser of claim 1, wherein the apparatus is a POS terminal.

8. The tape dispenser of claim 7, wherein the tape holder is installed at a position shifted in a direction of depth from a vicinity of an operation unit of the POS terminal.

9. The tape dispenser of claim 7, wherein the tape holder is installed at a position shifted in a direction of depth from a vicinity of a receipt issue port of the POS terminal.

10. The tape dispenser of claim 7, wherein the attachment member is a metal plate fixed on a bottom surface of the POS terminal.

11. A tape holder comprising an engaging member which removably engages with an attachment member for fixing on an apparatus, the tape holder holding an adhesive tape in a manner that allows the adhesive tape to be reeled out.
